(19) United States
(12) Patent Application Publication
(10) Pub. No.: US 2003/0048817 A1
(43) Pub. Date: Mar. 13, 2003

(54) Optical path length variation using a liquid crystal for tuning a laser

(75) Inventors: Wolf Steffens, Herrenberg (DE); Ullrich Kallmann, Tuebingen (DE)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/164,747

(22) Filed: Jun. 7, 2002

(30) Foreign Application Priority Data
Sep. 7, 2001 (EP) 01121409.5

(51) Int. Cl. H01S 3/10

(52) U.S. Cl. 372/20

(57) ABSTRACT

An apparatus for tuning a laser comprises an external cavity (2) for receiving a laser beam (4), the laser beam (4) traveling through material along a path (4) between a cavity end element (6) and a tuning element (8), the path (4) having an optical path length. A dispersion element (10) is introduced in the path (4) of the laser for selecting at least one mode of the laser, and a changing element is provided for changing the optical path length of the path (4). The changing element comprises a liquid crystal (32, 42) in at least a part of the path (4), the liquid crystal (32, 42) being sensitive in a characteristic property. The changing element is adapted for changing the characteristic property of the liquid crystal (32, 42) in a way which influences the optical path length of the path (4) to stabilize a mode of the laser.

### BACKGROUND OF THE INVENTION

The present invention relates to tuning a laser.

In the optical communication industry there is a need for testing optical components and amplifiers with lasers that can be tuned and influenced as required.

### SUMMARY OF THE INVENTION

Therefore, it is an object of the invention to provide improved influencing of a laser. The object is solved by the independent claims.

According to the present invention, a liquid crystals (LC) being sensitive in a characteristic property is applied in a path of a laser beam. The characteristic property can then be changed or varied for influencing the optical path length of the path.

The liquid crystals (LC) (in the following—for the sake of simplicity—only referred to as ‘material’) can be any allowing to controllably vary its optical path length by applying a control property or signal thereto. Preferred embodiments may comprise pressure or stress induced variations of the optical path length.

The present invention thus allows influencing the optical path length of the laser beam traveling e.g. in a cavity. The invention provides easy and precise influencing for tuning a laser beam, stabilizing a mode of a laser beam, and—in preferred embodiments—stabilizing the wavelength of the laser beam or filtering a certain wavelength of a laser beam. Influencing a laser according to the present invention makes it possible to enhance the quality of the laser beam produced by the used laser source or laser cavity just by using known laser sources or laser cavities and incorporating the invention.

By using LCs, the present invention can be realized simple and cheap. The LC can be connected to a voltage source and can be influenced therewith easily. Especially the refractive index of such a LC can be influenced by different voltages and/or currents applied to the LC. By placing such LC in the path on which a laser beam is traveling, the optical path length of such a path can be manipulated easily.

A preferred embodiment of the present invention is claimed in a parallel European patent application No. 01121408.7 filed by the applicant, which application is incorporated herein by reference.

In a further preferred embodiment, the change of the optical path length is modulated, preferably in a sinusoidal way. This can be done by providing a (e.g. sinusoidally) modulated electrical control signal for the LC that produces a (sinusoidal) optical path length variation. This leads to a frequency modulated output laser light with sidebands located at the carrier modulation frequencies and their higher harmonics if such LC is provided for tuning a laser.

For tuning a laser according to the invention, it is further preferred to change the optical path length to stabilize a mode of the laser beam within a small wavelength range. This range can be of the order of one mode spacing. In this embodiment, it is possible by a change of the optical path length to shift the lasing mode to the desired wavelength. This can also be done applying an external electrical signal to the LC as a control signal for the reflective index of the LC to tune the laser to the desired wavelength.

Another example of the inventive method provides a reduction of coherence of the laser light. This reduction can be used to avoid stimulated Brillouin Scattering or to avoid unwanted interference. A rapid change of the lasing mode wavelength by a change of the optical path length will produce laser light with these properties. An electrical control signal, which can be derived for example from random noise, can allow for the necessary optical path variations caused by the variation of the refractive index of the LC.

A preferred embodiment of the invention uses the LC being a part of an etalon. This can be done for example by using a LC with highly reflective coatings on both sides. In such a LC, the highly reflective coated sides are the etalon mirrors. The tuning effect is again due to the optical path length change between the two highly reflective coated etalon mirrors. This device can be placed in the cavity of a laser source and its transmission wavelength can be controlled by the applied electrical signal to the LC. Furthermore, it is possible to reduce light at unwanted wavelengths (for example Source Spontaneous Emission (SSE) or longitudinal side modes), if the tuning mechanism of the tunable laser source in which the LC is placed and the etalon transmission wavelength are at least approximately synchronized which each other.

Another preferred embodiment of the invention uses the LC in the path of the laser beam for providing a wave front correction of the laser beam. To achieve this goal the LC can be built to provide a spatial variation, preferably a lateral variation of its properties, e.g. the refractive index. This can be achieved for example by multiple electrodes on each side of a LC layer. Individually switched these electrodes can produce a controllable electrical field, which varies over the lateral expansion of the respective LC layer. This variation can be utilized to correct the wave front errors or to create wave fronts with controllable and/or defined characteristics. A preferred embodiment for wave front variations is to emulate a ‘lens’ by laterally varying (i.e. perpendicular to the propagation direction of the laser beam) the refractive index effect.

The above-mentioned LC devices have the advantage that they can be placed anywhere within a cavity of a laser source. They can be inserted as a transmissive device, placed anywhere in the beam path. Preferably, they are slightly tilted with respect to the incoming beam to avoid any unwanted multi mirror effects due to none perfect antireflection coatings of the respective LC. However, a LC can also be used a reflective device. For such a reflective device one side of the LC device is highly reflective coated and acts as a cavity mirror. However, it is clear that the body of the LC is still in the path of the laser beam. Therefore, the body of the LC is still a transmissive device. Moreover, the other side of such LC device can still be antireflective coated to allow for maximum transmission into the body of the LC.

Other preferred embodiments are shown by the dependent claims.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIGS. 1-4 show different embodiments of the present invention.

### DETAILED DESCRIPTION OF THE INVENTION

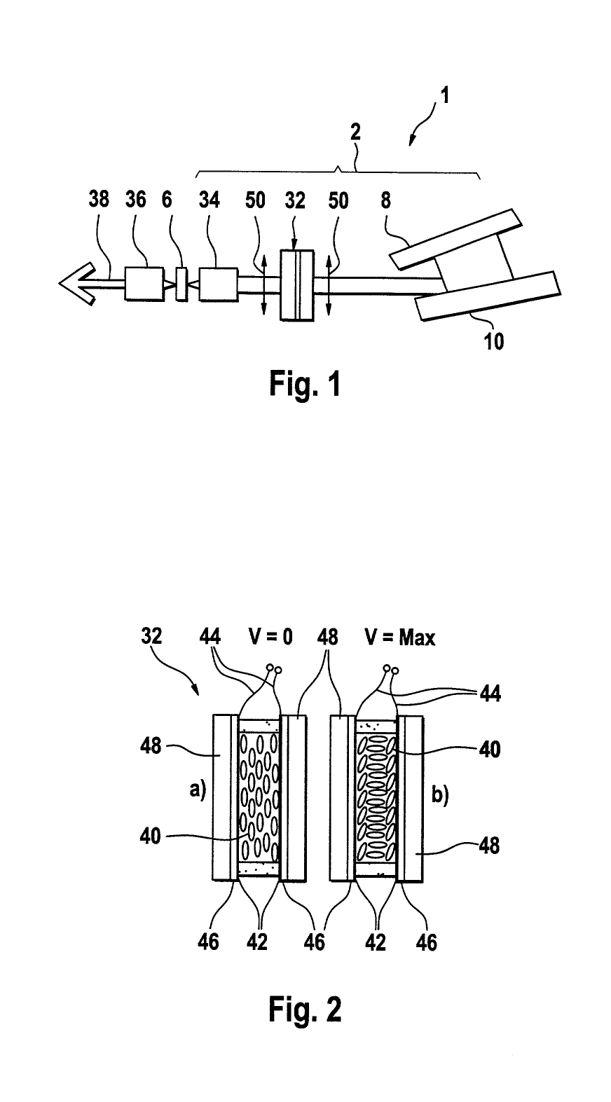

Referring now in greater detail to the drawings, FIG. 1 shows a schematic view of a first embodiment 1 of the apparatus of the present invention. The apparatus 1 of FIG. 1 comprises an external cavity 2, in which laser light provided by an active medium (not shown), e.g. a laser diode, can resonate to provide a laser beam 4. The beam 4 travels in the cavity 2 along a path between a cavity end element 6 and a tuning element 8 of the external cavity 2. The cavity end element 6 and the tuning element 8 both (providing a high reflective mirror) providing the cavity mirrors.

The apparatus 1 further comprises a dispersion element 10 introduced in the path of the beam 4 for selecting at least one, preferably a longitudinal, mode of the laser. The dispersion element 10 comprises a grating (not shown).

The tuning element 8 can be rotated by an actuator (not shown) about a pivot axis (not shown) to tune the laser. The pivot axis is theoretically defined by the intersection of the surface plane of the cavity end element 6, the surface plane of the dispersion element 10 and the surface plane of the tuning element 8.

It is clear that the positioning of the elements 6, 8, 10 according to FIG. 1 is only schematic and not the ideal case of the positioning of the elements 6, 8, 10. The elements 6, 8, 10 however can be positioned in another way, i.e. in other angles or positions as shown in FIG. 1.

In the path 4 of the laser beam there is introduced a liquid crystal LC 32. The LC 32 serves to change the optical length of the path 4 to at least partly compensate a shift between the real position of its rotation axis and the theoretically defined position (be aware that FIG. 1 is only a schematic illustration not to scale, therefore the axis is not shown). For further details about the predetermined path, reference is made to the parallel application mentioned above. In FIG. 1 are shown two collimators 34 and 36 to provide collimated laser light within the laser cavity (collimator 34) and to collimate the laser light 38 leaving the cavity end element 6 (collimator 36). The LC 32 is explained in further detail with respect to FIG. 2.

An example of a refractive index changing LC is shown in FIG. 2. The LC 32 is a so-called nematic LC retarder that provides phase shifts up to several pi. A phase shift of one pi corresponds to 1 mode spacing in cavity 2 with liquid crystal molecules 40. The liquid crystal molecules 40 are confined by two electrodes, here indium tin oxide (ITO) layers 46. The ITO layers 46 are contacted by wires 44 to receive a potential V. Part a) of FIG. 2 shows a situation with V=0. In this case, the liquid crystal molecules 40 are aligned parallel to each other. This alignment is induced by layers 42 located on layers 46. Layers 42 and 46 are supported by glass substrate layers 48. All layers 42, 46 and 48 are transparent for the laser light of light beam 4. However, liquid crystal molecules 40 in the LC 32 provide phase retardation to the laser light of light beam 4. This phase retardation is maximum with V=0 as shown in part a) of FIG. 2.

When V is at its maximum the phase retardation is at its minimum as shown in part b) of FIG. 2. In this case, the liquid crystal molecules 40 are only partly aligned to each other.

The LC 32 does not change the state of polarization of light beam 4 as indicated by arrows 50 in FIG. 1.

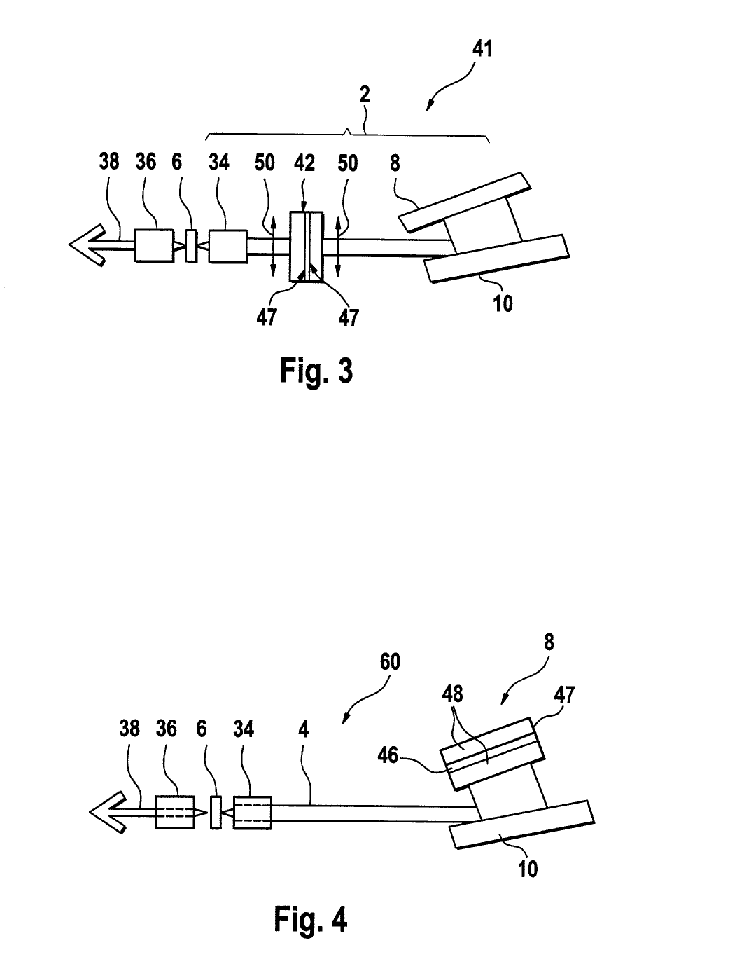

FIG. 3 shows a second embodiment 41 of the present invention. The general setup of embodiment 41 is similar to embodiment 1 of FIG. 1. However, in the path 4 of the laser beam there is introduced an etalon 42. The etalon 42 is built up by a LC 32 according to FIG. 2. The etalon 42 is slightly tilted with respect to the incoming beam 6 to avoid any unwanted multi mirror effects due to non perfect anti reflection coatings of the LC 32. However, the LC 32 is modified by two highly reflective coatings 47 placed on the inner surfaces of the ITO layers 46. Thereby, an etalon 42 is created which can be manipulated by the same electrical signal applied to etalon 42 of FIG. 2. However, by changing the voltage applied to etalon 42 the transmission wavelength of etalon 42 can be manipulated, preferably synchronized with the tuning mechanism of the tuning element 8 to reduce light of unwanted wavelength, for example SSE or longitudinal side modes.

FIG. 4 shows a fourth embodiment 60 of the present invention. In this embodiment, the LC 32 serves also as a tuning element 8. To serve as the tuning element 8 only one ITO layer is coated by a highly reflective coating 47.

1. A method of tuning a laser, comprising the steps of:
providing a laser beam to an external cavity, the laser beam traveling through a material along a path between a cavity end element and a tuning element, the path having an optical path length, and the material comprising a liquid crystal being sensitive in a characteristic property,
selecting a least one mode of the laser by introducing a dispersion element in the path of the laser, and
changing the optical path length of the path by changing the characteristic property of the liquid crystal in a way which influences the optical path length of the path to stabilize a mode of the laser.

2. The method of claim 1, wherein the characteristic property is at least one of thickness, optical path length, or refractive index.

3. The method of the claims 1, wherein the characteristic property is sensitive to at least one of voltage, magnetism, pressure, humidity, or temperature.

4. The method of claim 1, further comprising the step of:
modulating the change of the optical path length of the path.

5. The method of claim 4, wherein the change of the optical path length of the path is modulated using a modulation on a sinusoidal bases.

6. The method of claim 1, further comprising the step of:
varying the optical path length in a function of the spatial, preferably lateral, position in the laser beam.

7. The method of claim 1, further comprising the step of:
varying the characteristic property of the material spatially depending on the position in the laser beam.

8. The method of claim 7, wherein the characteristic property of the material is varied laterally.

9. The method of claim 1, further comprising the steps of:
measuring the real wavelength,
comparing the real wavelength with the desired wavelength, and
generating a control signal depending on the deviation for controlling the amount of change necessary to at least partly compensate any deviation of a real wavelength from a desired wavelength.

10. The method of claim 1, further comprising the steps of:
performing the change of the optical path length rapidly, preferably by deriving a control signal for the change from random noise to reduce the coherence of the laser.

11. The method of claim 1, further comprising the step of:
synchronizing tuning of the laser with a transmission wavelength of the etalon for reducing light at unwanted wavelengths.

12. A software program or product, preferably stored on a data carrier, for executing the method of claim 1, when run on a data processing system such as a computer.

13. An apparatus for tuning a laser, comprising:
an external cavity for receiving a laser beam, the laser beam traveling through material along a path between a cavity end element and a tuning element, the path having an optical path length,
a dispersion element introduced in the path of the laser for selecting at least one mode of the laser, and
a changing element for changing the optical path length of the path, the changing element comprising a liquid crystal in at least a part of the path, the liquid crystal being sensitive in a characteristic property, the changing element being adapted for changing the characteristic property of the liquid crystal in a way which influences the optical path length of the path to stabilize a mode of the laser.

14. The device of claim 13, wherein the characteristic property is at least one of thickness or refractive index of the material.

15. The device of the claims 13 or 14, wherein the characteristic property of the liquid crystal is sensitive to at least on of voltage, magnetism, pressure, humidity, or temperature.

16. The device of any one of claim 13, wherein the liquid crystal provides a spatial variation in its characteristic property.

17. The device of any one of the claims 16, wherein the liquid crystal provides a lateral variation in its characteristic property.

18. The device of any one of claim 13, wherein the liquid crystal is at least a part of an etalon.

19. A laser source, comprising:
an active medium adapted for providing a laser beam,
an external cavity adapted for providing resonance to the laser beam, the beam 4 traveling in the cavity along a path between a cavity end element and a tuning element, the cavity end element and the tuning element both providing the cavity mirrors,
a dispersion element introduced in the path of the beam for selecting at least one mode of the laser, and
a liquid crystal introduced in the path of the beam,
wherein the tuning element can be rotated about a pivot axis for tuning the laser, and the pivot axis is theoretically defined by the intersection of the surface plane of the cavity end element, the surface plane of the dispersion element and the surface plane of the tuning element, and
the liquid crystal is adapted to change the optical length of the path to at least partly compensate a shift between the real and the theoretically defined position of the pivot axis
